(19) United States
(12) Patent Application Publication
(10) Pub. No.: US 2009/0163340 A1
(43) Pub. Date: Jun. 25, 2009

(54) Paper folding machine

(75) Inventor: Tie-Chun Wang, SanChung City (TW)

Correspondence Address: BACON & THOMAS, PLLC, 625 SLATERS LANE, FOURTH FLOOR, ALEXANDRIA, VA, 22314-1176, US

(73) Assignee: Michilin Prosperity Co., Ltd., SanChung City (TW)

(21) Appl. No.: 12/081,257

(22) Filed: Apr. 14, 2008

(30) Foreign Application Priority Data
Dec. 19, 2007 (CN) 200720306527.2

(51) Int. Cl. B31B 1/26

(52) U.S. Cl. 493/405

(57) ABSTRACT

This specification discloses the structure of a paper folding machine that can automatically fold paper documents such as bills, flyers, and letters. The structure has a first paper folding plate and a second paper folding plate disposed correspondingly, and a first roller set and a second roller set disposed between the first paper folding plate and the second paper folding plate. Paper entering the paper folding machine is driven by the first and second roller sets to the first paper folding plate and the second paper folding plate in sequence for paper folding. In particular, the paper folding style can be changed by adjusting the positions of stopping blocks on the first and second paper folding plates.

### BACKGROUND OF THE INVENTION

1. Field of Invention

The invention relates to an auto paper folding machine for automatically folding paper documents, such as bills, flyers, and letters. It also provides a structure that can change the paper folding style.

2. Related Art

Due to the convenience of the Internet and E-mail messages, the advertising and postal costs of many companies are largely reduced. However, there are still many companies and institutes using postal mails to send out bills, flyers, or letters for delivering messages or as proofs of trade.

In addition to print out a huge amount of paper documents, these companies and institutes have to appropriately fold the printed bills, flyers, and letters before putting them into envelopes for mailing or distributing. This often requires considerable manpower and time. Besides, manual folding does not guarantee consistent format and size.

### SUMMARY OF THE INVENTION

An objective of the invention is to provide a structure of the paper folding machine for automatically folding paper documents such as bills, flyers, and letters and allowing changes in the folding style.

To achieve the above-mentioned objective, the disclosed paper folding machine includes a first paper folding plate and a second paper folding plate disposed correspondingly, and a first roller set and a second roller set disposed between the first paper folding plate and the second paper folding plate. Paper entering the paper folding machine is driven by the first and second roller sets to the first paper folding plate and the second paper folding plate in sequence for paper folding.

In an embodiment of the invention, the first and second paper folding plates are further provided with folding rulers on which stopping blocks are disposed in a adjustable way. The paper folding style can be changed by adjusting the positions of the stopping blocks.

### BRIEF DESCRIPTION OF THE DRAWINGS

The invention will become more fully understood from the detailed description given herein below illustration only, and thus is not limitative of the present invention, and wherein:

FIG. 1 shows a three-dimensional perspective of the invention;

FIG. 2 is a cross-sectional view of the disclosed structure;

FIG. 3 is a schematic view of automatic paper feed according to the invention;

FIG. 4 is a schematic view of manual paper feed according to the invention; and

FIG. 5 is a schematic view demonstrating that the disclosed paper folding machine can fold paper documents in various styles.

### DETAILED DESCRIPTION OF THE INVENTION

The present invention will be apparent from the following detailed description, which proceeds with reference to the accompanying drawings, wherein the same references relate to the same elements.

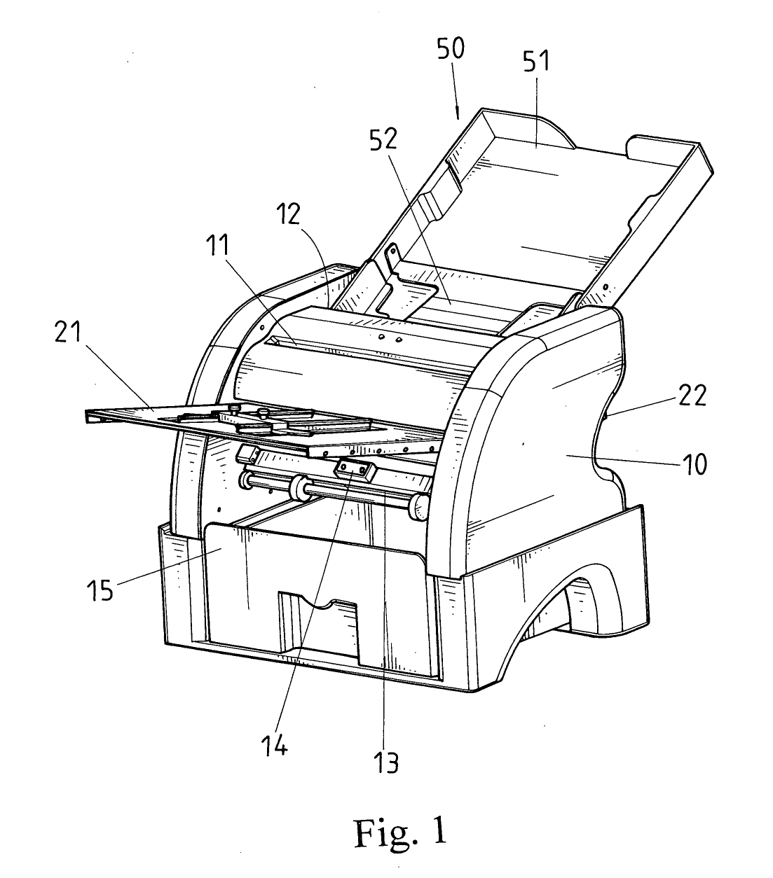

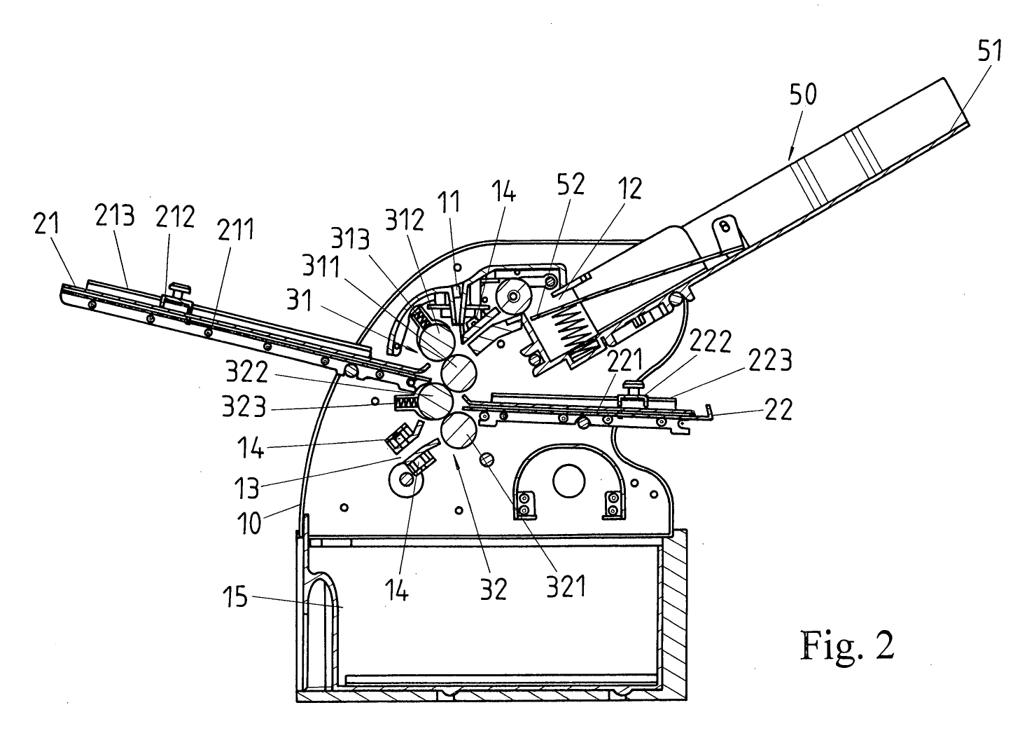

FIG. 1 shows a three-dimensional perspective of the invention. FIG. 2 is a cross-sectional view of the disclosed structure. As shown in the drawings, the disclosed paper folding machine includes: a machine body 10, a first paper folding plate 21, a second paper folding plate 22, a first roller set 31, a second roller set 32, and a motor 40.

The machine body 10 accommodates relevant components and has at least one paper inlet (the manual feed 11 and/or auto feed 12 in the drawings). The first and second paper folding plates 21, 22 are disposed on the machine body 10 with openings corresponding to each other. Each paper folding plate has a channel 211, 221 for paper sheets to enter. Blocks 212, 222 are disposed at the channels 211, 221 for blocking paper sheets. The first and second roller sets 31, 32 are disposed between the first and second paper folding plates 21, 22. They are driven by the motor 40 to rotate synchronously in order to feed paper sheets in the machine body 10. The paper sheets go through the first and second paper folding plates 21, 22 in sequence to complete the folding.

In an embodiment of the invention, the first and second roller sets 31, 32 comprise a fixed roller 311, 321 and a floating roller 312, 322, respectively. The floating rollers 312, 322 are in contact with the fixed rollers 311, 321 via springs 313, 323 to achieve the paper feeding and folding functions. Moreover, they can adjust for paper sheets of different thicknesses. The floating roller 322 in the second roller set 32 is pushed by the spring 323 against the fixed rollers 311, 321 of the first and second roller sets 31, 32 simultaneously. The paper sheet is thus pushed by the fixed roller 311 of the first roller set 31 and the floating roller 322 of the second roller set 32 to enter the second paper folding plate 22 and complete folding. The paper is then pushed by the fixed roller 321 of the second roller set 32 and the floating roller 322 of the second roller set 32 to leave the second paper folding plate 22.

Moreover, the first and second paper folding plates 21, 22 are further provided with paper folding rulers 213, 223. The above-mentioned blocks 212, 222 for blocking paper are disposed on the corresponding paper folding rulers 213, 223. Their relative positions can be adjusted in order to change the paper folding style (FIG. 5).

Besides, the machine body 10 has a manual feed inlet 11 and an auto feed inlet 12. An outlet 13 is provided in the direction that the paper is sent out from the second roller set 32. A sensor 14 is disposed at the auto feed inlet 12 and the outlet 13, respectively. The sensor 14 at the auto feed inlet 12 detects the source and feed-in of paper. The sensor 14 at the outlet 13 detects whether there is paper jam or missing.

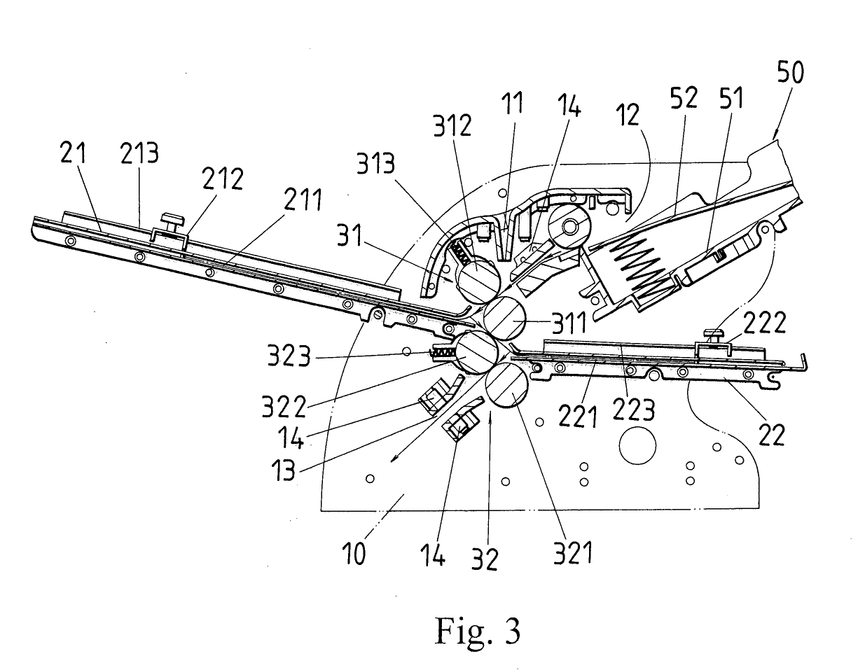

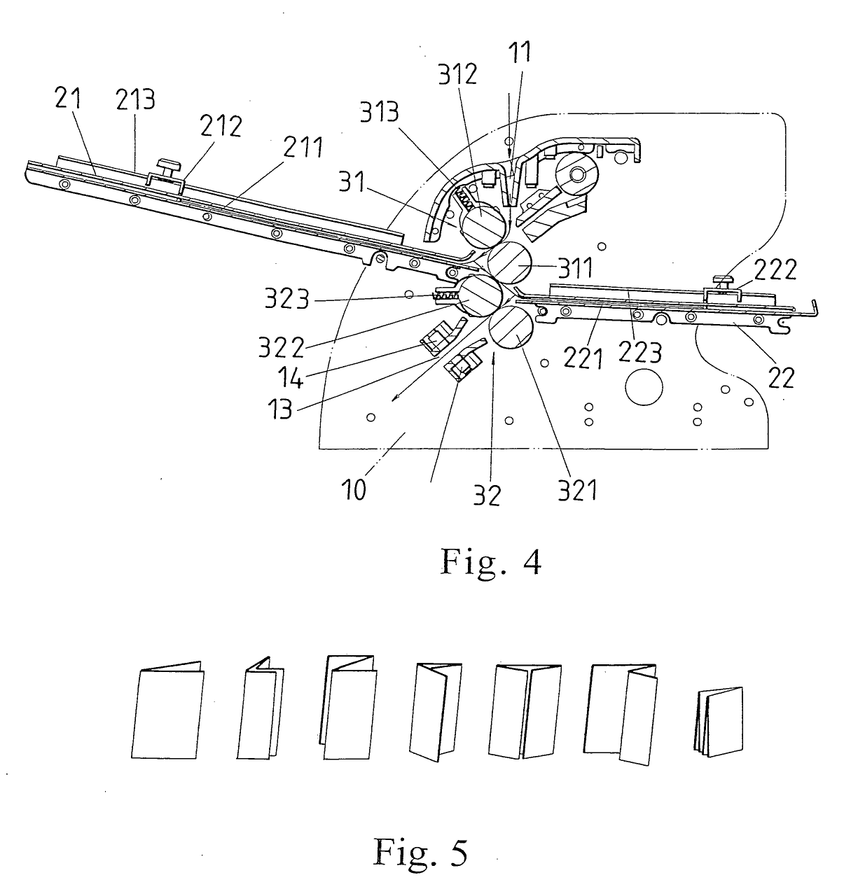

In practice, the auto feed inlet 12 of the machine 10 is equipped with an auto feed component 50 composed of a paper tray 51 and a distributor 52. The paper tray 51 holds a huge amount of paper documents. When the auto feed mode is selected, as shown in FIG. 3, the paper documents in the paper tray 51 are fed via the sensor 14 into the paper folding machine by the distributor 52. In the manual feed mode, there is no limitation of single sheet folding. As shown in FIG. 4, the user can use the manual feed inlet 11 to send in single or multiple sheets of paper for folding.

It should be noted that the auto feed component 50, the first paper folding plate 21, and the second paper folding plate 22 in the paper folding machine are fixed on the machine body 10 by insertion. Therefore, the auto feed component 50, the first paper folding plate 21, and the second paper folding plate 22 can be taken off. The paper folding machine can thus be easily assembled, disassembled, transported, and stored. In particular, the bottom of the machine body 10 can be provided with a container to collect folded paper documents.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A paper folding machine, comprising:
a machine body having at least one paper inlet;
a motor;
a first paper folding plate and a second paper folding plate disposed on the machine body in such a way that their openings correspond to each other, each having a channel for paper to go through and a block in the channel for stopping the paper;
a first roller set and a second roller disposed between the first and second paper folding plates, driven by the motor to rotate concurrently, thereby rolling the paper documents into the first and second paper folding plates in sequence for folding.

2. The paper folding machine of claim 1, wherein each of the first and second roller sets comprises a fixed roller and a floating roller, and each floating roller is in contact with the corresponding fixed roller by a spring.

3. The paper folding machine of claim 2, wherein the floating roller of the second roller set is in touch with the fixed rollers of the first and second roller sets.

4. The paper folding machine of claim 1, wherein each of the first and second paper folding plates is provided with a paper folding ruler, and each block is disposed on the corresponding paper folding ruler in an adjustable way.

5. The paper folding machine of claim 1, wherein the machine body has a manual feed inlet and an auto feed inlet.

6. The paper folding machine of claim 5, wherein an outlet is disposed in the direction that the second roller set sends out the paper.

7. The paper folding machine of claim 1, wherein the machine body has a manual feed inlet and an auto feed inlet, an outlet disposed in the direction that the second roller set sends out the paper, and a sensor at each of the auto feed inlet and the outlet.

8. The paper folding machine of claim 1, wherein the machine body has an auto feed inlet and an auto feed component disposed at the auto feed inlet.

9. The paper folding machine of claim 8, wherein the auto feed component comprises a paper tray and a distributor.

10. The paper folding machine of claim 8, wherein the auto feed component is fixed on the machine body by insertion.

11. The paper folding machine of claim 1, wherein the first and second paper folding plates are fixed on the machine body by insertion.

12. The paper folding machine of claim 1 or 8, wherein a container is provided at the bottom of the machine body.
